(19) United States
(12) Patent Application Publication
(10) Pub. No.: US 2005/0203447 A1
(43) Pub. Date: Sep. 15, 2005

(54) Waterproof hydrotherapy limb massager

(75) Inventors: Robert J. Pisani, York, PA (US); James A. Horton, Lancaster, PA (US)

Correspondence Address: LAW OFFICES OF STUART J. FRIEDMAN, 28930 RIDGE ROAD, MT. AIRY, MD, 21771, US

(73) Assignee: Robert J. Pisani, York, PA (US)

(21) Appl. No.: 11/075,196

(22) Filed: Mar. 8, 2005

Related U.S. Application Data
(60) Provisional application No. 60/551,245, filed on Mar. 9, 2004.

(51) Int. Cl. A61H 9/00; A61H 23/04

(52) U.S. Cl. 601/55; 601/158; 601/160

(57) ABSTRACT

A hydrotherapy massage apparatus for the limbs of a patient having a water-tight chamber and a limb-receiving and surrounding waterproof, flexible sleeve extending longitudinally through an opening in the front wall of the chamber for insertion of the limb to be massaged into the chamber. At least one continuous hollow water head surrounds the sleeve and has opposed, peripherally spaced apart openings facing the sleeve through which water jets may be directed upon peripherally spaced apart portions of the limb within the sleeve.

### CROSS-REFERENCE TO RELATED APPLICATIONS

This is a non-provisional application based upon U.S. provisional application Ser. No. 60/551,245, filed Mar. 9, 2004, now pending.

### FIELD OF THE INVENTION

The present invention relates to hydrotherapy massage apparatus and, more particularly, to an apparatus which employs pulsating water jets surrounding a limb which is supported in a sleeve of waterproof material.

### BACKGROUND OF THE INVENTION

Hydromassage for therapeutic purposes has been practiced in many forms for many years. One form of hydromassage employs a tank or tub of water in which a patient immerses all or a portion of its body. Massage is achieved by forcing air into the tank to produce a whirlpool effect and/or introducing and removing water of contrasting temperature levels. In another form, water of predetermined temperature and pressure is introduced into the tank to produce a spiral or circulatory motion to the liquid. In still another form, the tank includes a plurality of water injection nozzles spaced around its inside surface for introducing a pulsating flow of water and air into the tank. However, it is inconvenient for most patients to get wet during the hydromassage. Accordingly, there have been developed numerous forms of hydromassage which employ waterproof coverings of one form or another to avoid wetting the patient during therapy. One such waterproof form uses a waterproof cuff surrounding the body portion to be treated and pulsating water is introduced either directly into the cuff or into coils within the cuff. In another waterproof form, the patient inserts a limb to be treated into an opening in a cabinet of multi wall construction. Water is introduced into the walls of the cabinet out of contact with the patient for applying fluid pressure at spaced locations along the limb.

U.S. Pat. No. 5,158,076 to Thomsen discloses a water jet massage apparatus for the entire body of a patient. The apparatus employs pulsating water jets positioned above a reclining patient with a waterproof sheet of flexible material interposed between the patient's body and the water jet heads in order to assure that the patient remains dry. The waterproof sheet comprises the bottom wall of the lid of the massage apparatus, which itself is elongated, hollow, completely enclosed and water tight and is supported above the patient, with the flexible, waterproof bottom wall overlying the patient, as the patient reclines on a base. A laterally extending water manifold supports a plurality of pulsating jets in a configuration whereby the jets of water are directed onto the flexible bottom wall of the lid. The manifold is arranged for longitudinal rolling movement on side rail tracks extending substantially along the full length of the lid and along the length of the reclined patient. After striking the bottom wall of the lid, the spent water drains into gutters from which it is recycled into a water reservoir for reheating and reuse.

Notwithstanding the foregoing prior art attempts to provide hydrotherapy apparatus, none are particularly suitable or effective for applying hydrotherapy to a patients limbs, particularly its arms. It should be apparent that efforts to date suffer from one or more shortcomings which make the apparatus unnecessarily complicated, expensive or insufficiently effective in use. Accordingly, there still exists a need for an economical, simple and effective apparatus for limb hydrotherapy massage by utilizing pulsating and impacting jets of water while assuring that the patient remains dry throughout.

### SUMMARY OF THE INVENTION

It is, therefore, a primary object of the present invention to provide a hydrotherapy massage apparatus, especially for the limbs of an individual, which allows the individual to remain dry and fully clothed throughout the therapy.

It is also an object of the present invention to provide a hydrotherapy massage apparatus which utilizes pulsating jets of water which impact the limb to be treated around its entire periphery as well as along its entire length.

It is another object of the present invention to provide a hydrotherapy massage apparatus utilizing water jet rings surrounding the limb for providing pulsating jets of water which alternately impact the limb at different positions around the limb periphery.

It is yet another object of the present invention to provide a hydrotherapy massage apparatus which allows either the user or the operator control over the massaging action of the jets.

It is still another object of the present invention to provide a hydrotherapy apparatus apparatus which is economical to manufacture and use.

The foregoing and other objects are achieved in accordance with the present invention by providing a hydrotherapy massage apparatus for the limbs of a patient comprising:

a water-tight, elongate limb-receiving chamber comprising front, back, top, bottom and side walls, a limb-receiving waterproof, flexible sleeve extending longitudinally in said chamber, an opening defined in the front wall of the chamber and communicating with said sleeve through which the limb to be massaged is inserted into said chamber, said sleeve adapted to surround said limb in said chamber;

at least two hollow water heads spaced apart about the periphery of said sleeve within said chamber and mounted for longitudinal movement along the length of said sleeve in said chamber, each said head having at least one opening facing said sleeve through which water jets may be directed upon peripherally spaced apart portions of said limb within said sleeve;

means for providing pulsating jets of water under pressure to said openings;

means for moving said water heads longitudinally, back and forth, along at least a portion of the limb within said sleeve; and

means for draining water expelled through said openings from said water tight chamber.

In another aspect of the invention, there is provided a hydrotherapy massage apparatus for the limbs of a patient including a continuous hollow water head surrounding said sleeve within said chamber, said water head having peripherally spaced apart openings facing the sleeve.

In still another aspect of the invention, there is provided a hydrotherapy massager for the limbs of a patient including hollow continuous hollow water heads longitudinally spaced apart along the sleeve, each of the water heads surrounding the sleeve within the chamber and having peripherally spaced apart openings facing the sleeve.

In yet another aspect of the invention , there is provided a hydrotherapy massager for the limbs of a patient wherein the longitudinally spaced apart continuous hollow water heads are ring tori and each ring torus has a first set of one or more openings positioned diametrically opposed to a second set of one or more openings and wherein the diameters connecting the first and second sets of openings in each torus form an angle with each other, the angle being desirably about 90°.

In a further aspect of the invention, there is provided a method of massaging the limbs of a patient with pulsating jets of water comprising the steps of surrounding and enclosing the limb to be massaged with a waterproof, flexible sleeve, surrounding said sleeve with at least two hollow water heads having spaced apart openings facing said sleeve, directing pulsating jets of water against the sleeve from said spaced apart openings while, at the same time, moving said water head longitudinally, back and forth, along said sleeve to massage longitudinally spaced portions of the limb within said sleeve while, at the same time, massaging peripherally spaced portions of the limb.

### BRIEF DESCRIPTION OF THE DRAWINGS

FIG. 1 is a perspective transparent view of the hydrotherapy arm massager of the present invention.

FIG. 2 is a perspective view of the arm receiving enclosure with the walls cut away to show the features of the interior thereof.

FIG. 3 is a perspective view of the water supply enclosure with the walls cut away to show the features of the interior thereof.

FIG. 4 is a perspective view of an individual with his arm positioned within the arm receiving cabinet receiving hydrotherapy massage.

FIG. 5 is a perspective view showing the underside of the torus support and slide plates.

FIG. 6 is a perspective view showing the torus support and slide plates and the chain drive mechanism therefor.

FIG. 7 is a cutaway perspective view showing the arm sleeve mounted to the arm receiving cabinet and the support means for the sleeve.

FIGS. 8a and 8b are perspective views showing, separately, each of two tori and the positioning of the nozzles therein.

FIG. 9 is a perspective view of the water pulsing and distribution valve for use with the hydrotherapy arm massager of the present invention.

FIG. 10 is a block diagram showing the control circuitry for the hydrotherapy arm massager.

### DESCRIPTION OF THE PREFERRED EMBODIMENT

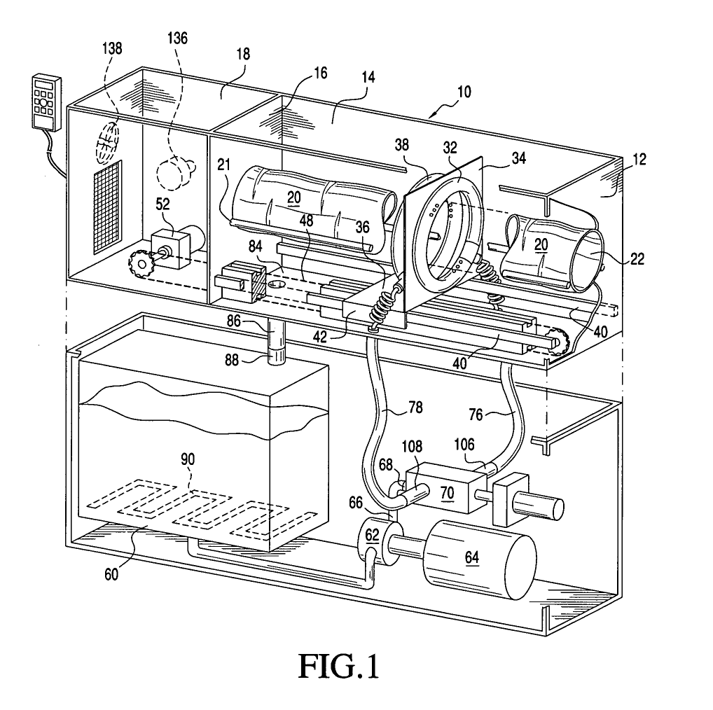

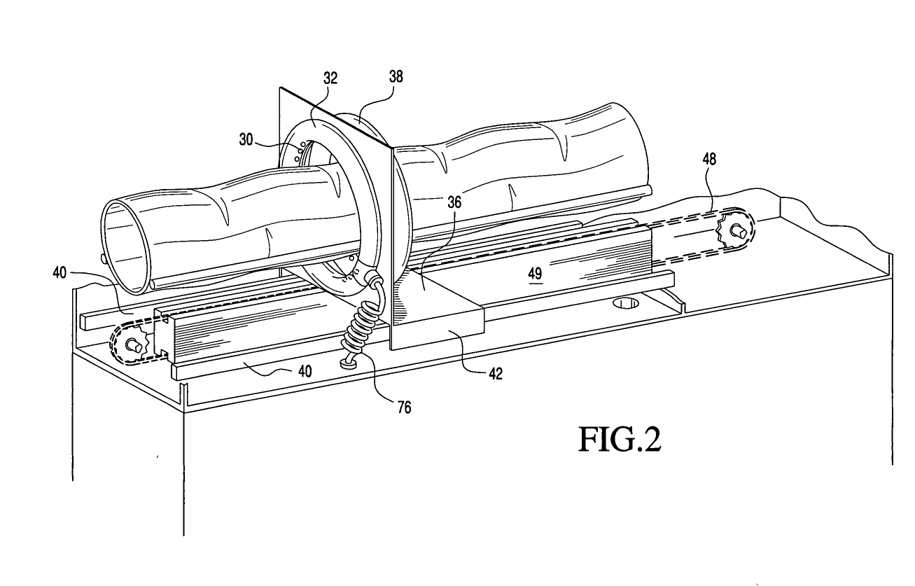

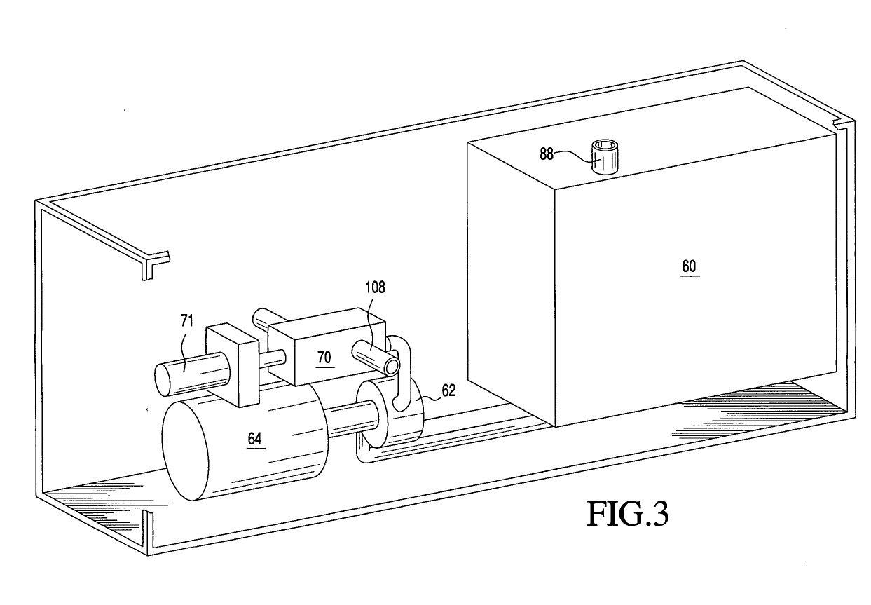

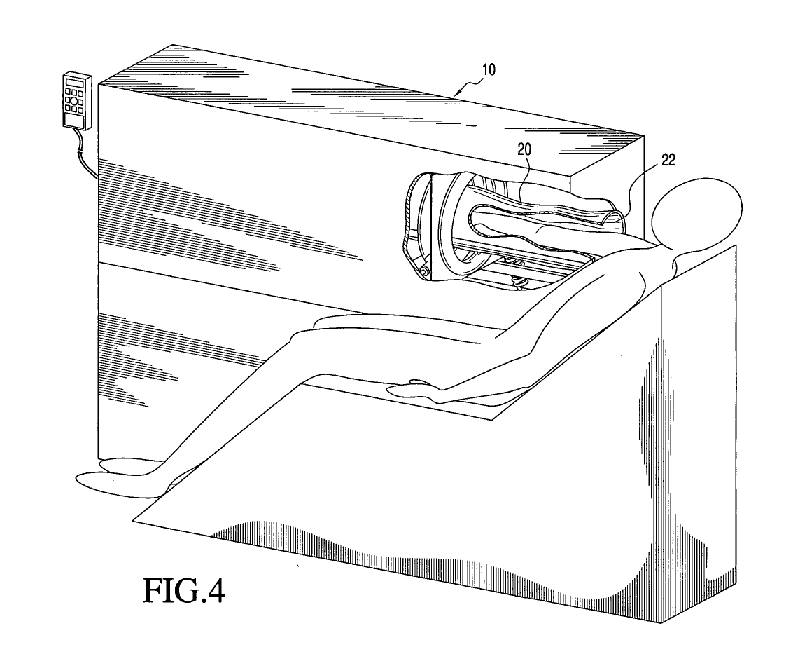

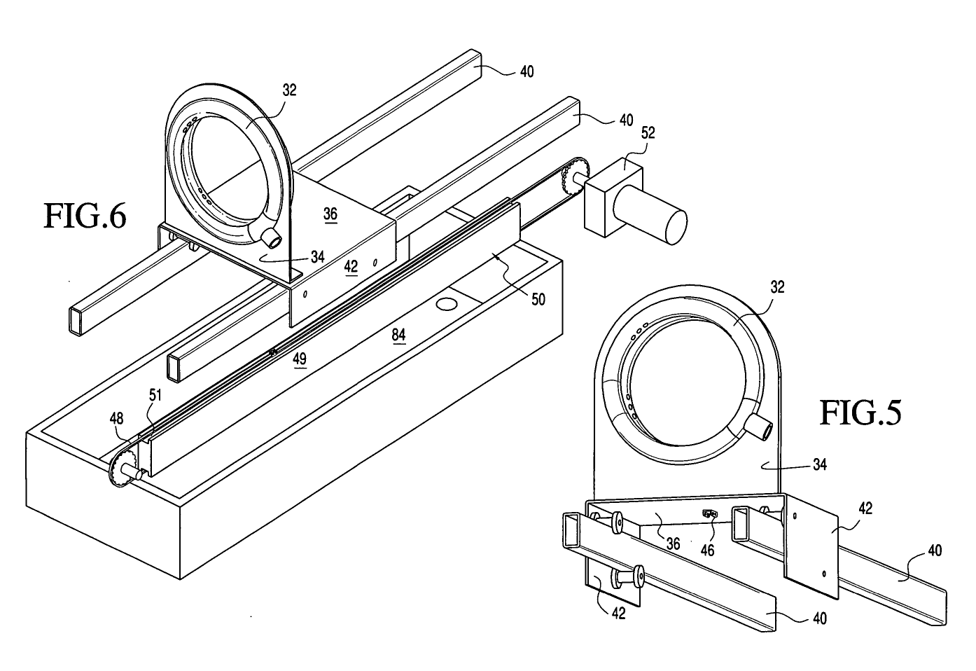

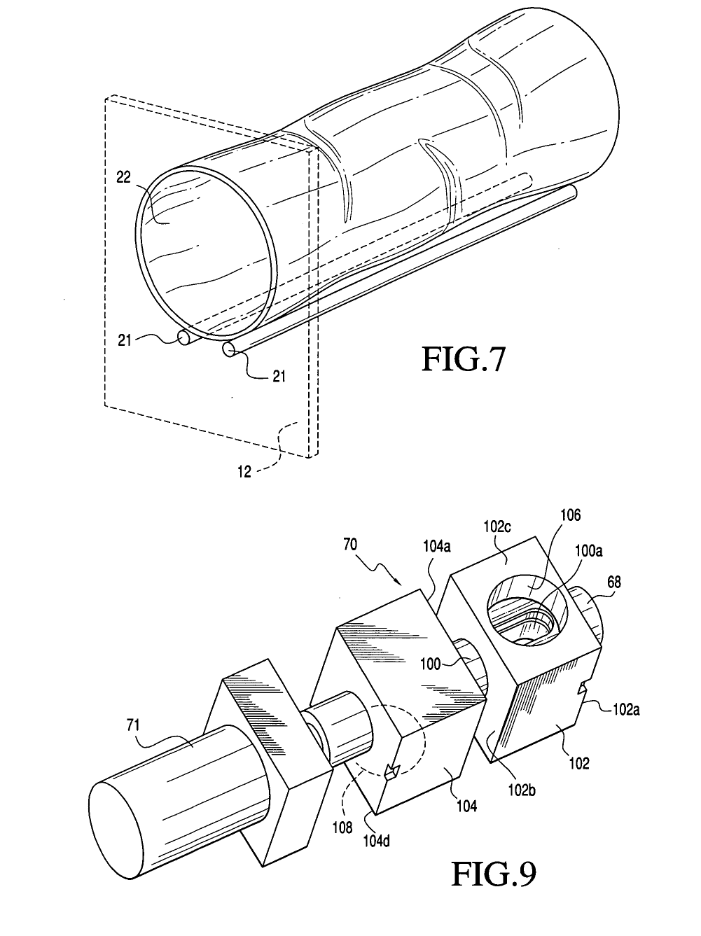

The hydrotherapy arm massager, as shown in FIGS. 1-9, generally includes a water-tight, preferably stainless steel, fiberglass, plastic or combinations thereof, arm enclosure 10 having an end wall 12 through which a patient's arm is inserted into the interior massage chamber 14. Remote from the end wall 12 and adjacent massage chamber 14, but separated therefrom by waterproof bulkhead 16, is a control chamber 18 which houses an electric motor, drive gears, control electronics, an optional cooling fan 138 and an optional encoder 136, all as will be discussed more fully hereinafter. The open end of a waterproof, flexible one-size-fits-all sleeve 20 communicates with and extends into chamber 14 from opening 22 formed in end wall 12. Sleeve 20 loosely receives the arm of a patient and is appropriately dimensioned for that purpose. The end of sleeve 20 within chamber 14 is closed so that the patient's arm is protected from direct contact with the water expelled from water jets, which provide the hydrotherapy massage. It is desirable that the material from which the sleeve 20 is formed, e.g., vinyl, rubber, or other flexible, material, be not only waterproof but also as thin as possible in order to maximize the massage sensation of water striking the patient's protected arm. In another form of the invention, sleeve 20 is elastic, stretchable and tight fitting, and formed of as thin a material as possible. Sleeve 20 is supported by at least two longitudinally extending, i.e., in the direction of the inserted arm, plastic or metal rods 21 supported from bulkhead 16 and wall 12, so that the patient may rest its arm upon the rods when the arm is in chamber 14. In lieu of rods, other means of arm support may be utilized, such as a waterproof net suspended between bulkhead 16 and wall 12.

Massage is accomplished within the chamber 14 by introducing water into the chamber and directing it in a pulsating manner onto the arm of the patient covered by sleeve 20. The impact of the water upon the sleeve forces the sleeve into contact with the patient's arm, if it wasn't already in such contact. By using water under pressure and directing pulsating jets of water, alternately, at different locations around the periphery of the arm, while at the same time causing the water jets to move longitudinally along the length of the arm, the entire arm, or any selected portion of it, can be hydromassaged.

Water jets 30 are positioned circumferentially spaced apart about at least a portion of a first ring torus 32 to which pulsating water under pressure is supplied. Torus 32 is mounted on a torus support plate 34 which is mounted on slide plate 36 for longitudinal sliding movement along the length of sleeve 20, which extends through torus 32. In a preferred embodiment, shown in the FIGURES, a second ring torus 38 is mounted on the opposite side of torus support plate 34, so that torus 38 is in back-to-back relationship with torus 32, and both torus 32 and torus 38 are moved longitudinally along the length of sleeve 20.

The movement of slide plate 34 is controlled by means of a longitudinal movement control 50. In the preferred embodiment, a pair of laterally spaced apart, longitudinally extending rails 40 extend along the length of chamber 14 and are supported by bulkhead 16 and wall 12. Sliding plate 36 has a wall 42 depending from each lateral side thereof and the rails 40 are so positioned within chamber 14 that the slide plate 36 rests upon the rails 40 with the depending walls 42 along the outsides of the rails 40, so that slide plate 36 straddles the rails 40, as can most clearly be seen in FIG. 5. Extending inwardly from the inside of walls 40 are rollers 44 which ride above and below rails 40 to hold the slide plate 36 on the rails and to facilitate its smooth movement along the rails. Depending from the underside of slide plate 36 are lugs 46 which attach to chain 48 of the longitudinal movement control 50. Chain 48 is desirably mounted on a plastic block chain support 49 and runs in a groove 51 formed therein. Chain 48 is driven by a reversible DC gear stepper motor 52 which is housed within control chamber 18. Alternatively, the longitudinal control means could be a screw type cam rod, which feeds through a screw feed support on the torus support plate 34 and which is driven by a stepper motor through reduction gears. In another alternative, the longitudinal control means could be a cable assembly driven by a motor and using drive pulleys, as is taught in U.S. Pat. No. 5,158,076.

Water under pressure is drawn from a reservoir 60, which feeds the suction of a pump 62 driven by an electric motor 64. The pump outlet 66 provides water into the inlet 68 of a pulsating and distributing valve 70. A central spindle 100 of valve 70 rotates under the power of a pulse control DC motor 71, for supplying pulsating water, alternately, to two outlets 106,108, connected via flexible plastic hoses 76,78, which pass through the bottom of pan 84 to the inlets 80,82 of each of the tori 32,38. Increasing the frequency of rotation of spindle 100 of valve 70 increases the pulsating water jet frequency. It will be appreciated that by virtue of pulsating and distributing valve 70 supplying pulsating water, alternately, to each of its outlets, pulsating water is fed alternately to each of the tori.

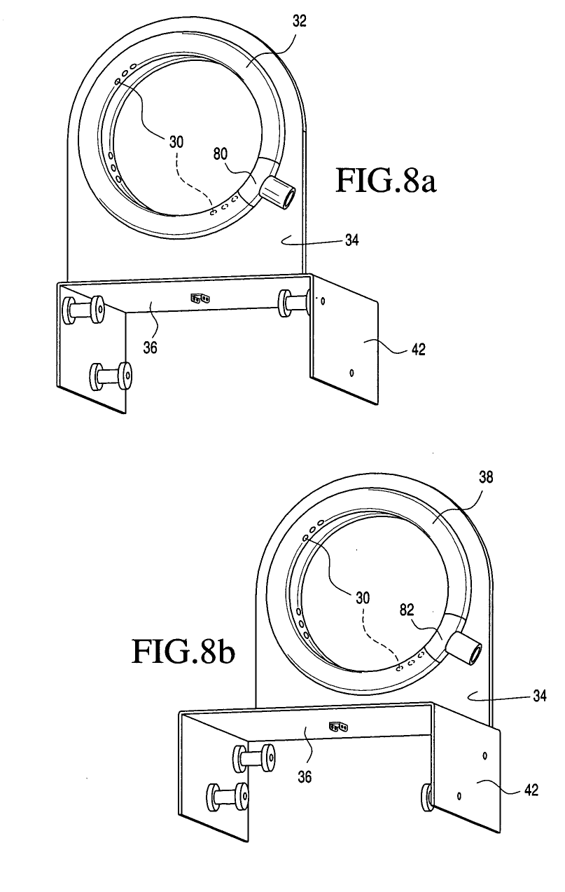

In a preferred embodiment, the water jets 30 on each torus 32,38 are positioned at different circumferential positions. For example, a furst series of circumferentially spaced apart jets 30 on torus 32 may advantageously be positioned between about 10-11 o'clock and a second series of circumferentially spaced apart jets may be positioned diametrically opposed between about 4-5 o'clock on torus 32, as you view torus 32 from arm opening 22 (the top center of the torus is 12 o'clock). On torus 38, which is positioned on the back side of torus 32, a first series of circumferentially spaced apart jets 30 may be positioned between about 7-8 o'clock and a second series of jets may be positioned diametrically opposed between about 1-2 o'clock as you view torus 38 from arm opening 22 (the jets on torus 38 appear to be at 10-11 o'clock and 4-5 o'clock as you view torus 38 from control chamber 18, see FIG. 8b). Thus, it can be seen that the diameters connecting the first and second series of jets on each torus 32,38 form an angle with each other and that the angle is desirably about 90°. It is preferred when, as here, the patient's arm is not securely held within arm receiving chamber 14 that the water jets on each torus are diametrically opposed so that the force of the water jets striking the patient's arm does not cause the patient's arm to move. It will be appreciated, at any instant in time, an arm positioned in sleeve 20 will be subjected to jet streams of water from the jets 30 on torus 32 and, at the next instant from the jets 30 on torus 38. Thus, during each brief interval, certain circumferential positions on the arm are being struck by water jets and, shortly thereafter, other circumferential positions on the arm are being struck by the water jets.

During the course of a hydrotherapy massage, support plate 34 mounting tori 32, 38 makes a longitudinal sweep along the length of the patient's arm and, when it reaches one end of its sweep, reverses direction and makes another longitudinal sweep until it reaches the other end of its sweep, whereupon it reverses direction again, and this sweeping in alternate directions continues throughout the massage session. Electrical limit switches or sensors (not shown) fixed at each end of the sweep, for example, on the inside walls of the interior massage chamber 14, and keyed to the position of the support plate 34, limit the maximum length of a sweep. A pair of longitudinally slidable electrical switches or repositionable sensors (not shown) positioned intermediate the limit switches or sensors are slidable/repositionable between the limit positions to define a smaller length of sweep, for example if it is desired to focus the massage on a particular portion of the arm, such as the wrist. A control is provided, operable either by the patient or the operator, to cause the longitudinal sweeping of the support plate 34 to stop in order to massage a particular location on a patient's arm.

In another embodiment of the invention, at least one torus is provided with circumferentially spaced apart, diametrically opposed openings facing the sleeve 20. The at least one torus is caused to rotate about a central axis parallel to the patient's arm to massage circumferentially different locations on the arm as the torus rotates and makes a longitudinal sweep along the patient's arm.

During a massage, the jet streams of water impact, desirably from diametrically opposed jets, alternately on different circumferential, and impact on different longitudinal, positions of the sleeve 20. After the water streams strike the sleeve, the water drips off and is collected at the bottom of pan 84, which includes a drain outlet at the bottom. In a preferred form of the invention, the floor of pan 84 is inclined toward a pan drain outlet. The water from the drain is conducted, via conduit 86 to the inlet 88 of reservoir 60, and is recycled through the pump 62 and valve 70 to tori 32,38. Water within the reservoir 60 may be heated by means of a water heating element 90 immersed in the liquid within reservoir 60.

Pulsating and distributing valve 70, as shown in FIG. 9, is a DC motor driven valve which receives water under pressure from pump 62 into one end 68 of a longitudinally extending hollow spindle 100 which is caused to rotate by the DC motor 71. The spindle 100 is rotatably received in two longitudinally spaced apart housings 102, 104, each having a single outlet opening. As can be seen in FIG. 9, housing 102 is generally cube shaped, having an opening in one face 102a for rotatably receiving spindle 100 and a corresponding opening in opposite face 102b through which spindle 100 can pass and be rotatably received into an opening in face 104a of cube-shaped enclosure 104. Spindle 100 terminates within enclosure 104. Enclosure 102 has an outlet opening 106 in face 102c and enclosure 104 has an outlet opening 108 in face 104d, which opens in a direction opposite to the direction in which opening 106 faces. Spindle 100 has a first opening 100a, which is positioned to allow water that flows under pressure into spindle 100 to flow out of opening 106 in enclosure 102 at one rotational position of spindle 100. Spindle 100 has a second opening 100b (not shown) longitudinally downstream of opening 100a which is positioned to allow water that flows under pressure into spindle 100 to flow out of opening 108 in enclosure 104 at a rotational position of spindle 100 which is 180° out of phase with the rotational position of spindle 100 when opening 100a is aligned with opening 106. When opening 100a is in registry with opening 106, opening 100b is not in registry with opening 108. Conversely, when opening 100b is in registry with opening 108, opening 100a is not in registry with opening 106. Thus, as spindle 100 is rotated by its DC motor, it alternately allows water under pressure to flow out of openings 106 and 108, thereby creating a pulsating flow of water which is fed by hoses 76,78 to the inlets 80,82 of tori 32,38.

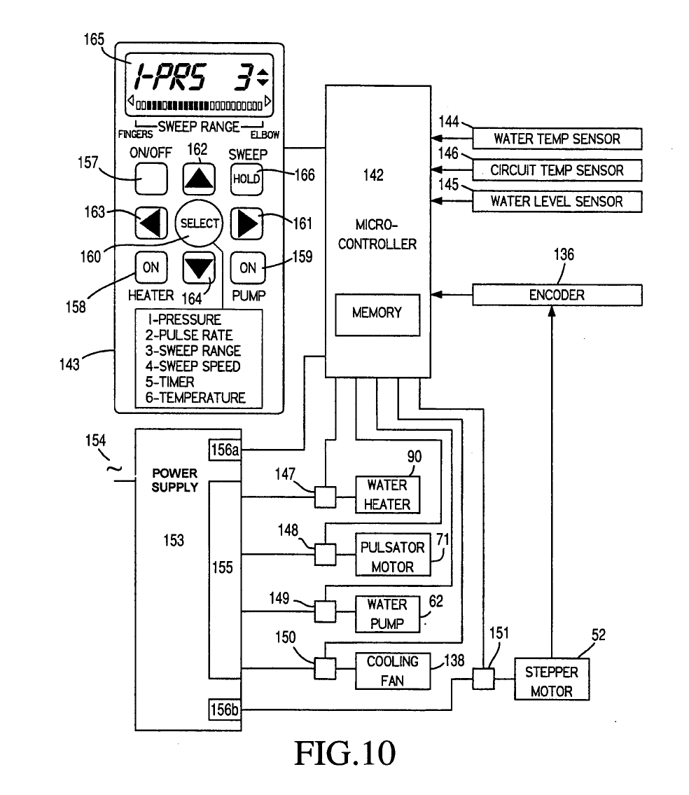

FIG. 10 shows a preferred embodiment of the main control circuitry used to provide control functions to massager 10. Control functions are implemented by means of a processor or embedded processor device, like a microcontroller 142 that receives input control information from the user via remote control 143, and input information from a water temperature sensor 144, water level sensor 145, circuit temperature sensor 146 and encoder 136. Microcontroller 142 also instigates control through a series of control circuits 147, 148, 149, 150 and 151 for controlling the water heater 90, pulsator motor 71, water pump 62, optional cooling fan 138 and stepper motor 52, respectively. Control circuit 147 is a dc-controlled ac on/off switch such as an SCR-type circuit, or relay, that turns on/off water heater 90. Alternatively, the circuit can thermostatically control water heater 90 to achieve a desired water temperature. Control circuit 148 is a dc-controlled ac motor speed-controlled circuit that alters the speed of pulsator motor 64. control circuit 149 is a dc-controlled ac-powered variable control circuit that alters the power deliver to pump 62. Control circuit 150 is a dc-controlled ac on/off switch, such as an SCR-type circuit, or relay, that turns on/off optional cooling fan 138. Control circuit 151 is a dc controlled stepper motor drive circuit that sets the stepping rate and stepping direction of stepper motor 52. Encoder 136 is linked to longitudinal movement control 50 to record the position of support plate 34, which is used by microcontroller 142 to determine the position of turi 32, 38 relative to the minimum and maximum sweep positions.

Power is supplied to all electronics via a power supply unit 153, which receives mains ac power 154 and provides a mains-level ac power port 155 fed to circuits 147, 148, 149 and 150. Supply 153 also provides regulated dc port 156a for logic circuits, such as microcontroller 142. Supply 153 provides an additional dc port 156b that is fed to circuit 151.

Referring to FIG. 10, ON/OFF button 157 of remote control 143 acts to turn on/off main power to the massager 10. Heater ON/OFF button 158, and pump ON/OFF button 159 are used to selectively turn on/off heater 90 and pump 62, respectively, once main power is on. Select button 160 is used to select water pressure level of water jets 30, pulse rate implemented by valve 70, sweep speed of tori 32,38, sweep range of tori 32,38 between minimum and maximum positions or to cause tori 32,38 to cease longitudinal motion in order to massage a single location on the patient's arm, duration (time) of massage session, and temperature of water. Arrow buttons 161, 162, 163, 164 are used to alter function characteristics, such as pressure level, sweep range points, speed of tori 32,38 travel, sweep duration and temperature, all of which are displayed on a LCD or LED display 165. Sweep/hold button 166 is used to pause or hold the motion of tori 32,38 during its programmed sweep.

The present invention has been described in terms of an arm massager. However, it will be appreciated that a like massager, perhaps modified slightly in its dimensions, could be used to provide hydrotherapy massage to the leg of a patient. While the present invention has been described in terms of specific embodiments thereof, it will be understood that no limitations are intended to the details of construction or design other than as defined in the appended claims.

1. A hydrotherapy massage apparatus for the limbs of a patient comprising:
a water-tight, elongate limb-receiving chamber comprising front, back, top, bottom and side walls, a limb-receiving waterproof, flexible sleeve extending longitudinally in said chamber, an opening defined in the front wall of the chamber and communicating with said sleeve through which the limb to be massaged is inserted into said chamber, said sleeve adapted to surround said limb in said chamber;
at least two hollow water heads spaced apart about the periphery of said sleeve within said chamber and mounted for longitudinal movement along the length of said sleeve in said chamber, each said head having at least one opening facing said sleeve through which water jets may be directed upon peripherally spaced apart portions of said limb within said sleeve;
means for providing pulsating jets of water under pressure to said openings;
means for moving said water heads longitudinally, back and forth, along at least a portion of the limb within said sleeve; and
means for draining water expelled through said openings from said water tight chamber.

2. A hydrotherapy massager, as claimed in claim 1, wherein said at least two hollow water heads comprise a continuous hollow water head surrounding said sleeve within said chamber, said head having peripherally spaced apart openings facing said sleeve.

3. A hydrotherapy massager, as claimed in claim 2, wherein said peripherally spaced apart openings comprise openings in said head which are positioned to direct water jets upon peripherally opposing portions of said limb within said sleeve.

4. A hydrotherapy massager, as claimed in claim 1, wherein said at least two hollow water heads comprise at least two continuous hollow water heads longitudinally spaced apart along said sleeve, each of said hollow water heads surrounding said sleeve within said chamber and having peripherally spaced apart openings facing said sleeve.

5. A hydrotherapy massager, as claimed in claim 4, wherein said peripherally spaced apart openings comprise openings in each of said heads which are positioned to direct water jets upon peripherally opposing portions of said limb within said sleeve.

6. A hydrotherapy massager, as claimed in claim 5, wherein said at least two continuous hollow water heads are closely spaced apart along said sleeve.

7. A hydrotherapy massager, as claimed in claim 6, wherein said at least two continuous hollow water heads comprise two hollow water heads mounted on opposite sides of a support plate, said sleeve extending through said support plate.

8. A hydrotherapy massager, as claimed in claim 6, wherein said continuous hollow water heads comprise ring tori.

9. A hydrotherapy massager, as claimed in claim 8, wherein each said ring torus of adjacent ring tori has a first set of one or more openings positioned diametrically opposed to a second set of one or more openings and the diameters connecting the first and second sets of openings in each ring torus form an angle with each other.

10. A hydrotherapy massager, as claimed in claim 9, wherein said angle is about 90°.

11. A hydrotherapy massager, as claimed in claim 9, wherein said at least two tori comprise two tori closely spaced apart along said sleeve.

12. A hydrotherapy massager, as claimed in claim 10, wherein said at least two tori comprise two tori closely spaced apart along said sleeve.

13. A hydrotherapy massager, as claimed in claim 1, wherein said means for providing pulsating jets of water under pressure to said openings includes a pulsating and distributing valve, said valve comprising an elongate hollow spindle for receiving water under pressure, said spindle being water-tightly rotatable within two spaced apart housings along said spindle, each of said housings having a water outlet, said housing water outlets being rotatationally spaced apart from each other, said spindle having a first water outlet within said first housing and a second water outlet within said second housing, said spindle water outlets being rotationally spaced apart from each other, whereby, as said spindle rotates, said first spindle water outlet comes into registry with said first housing water outlet while said second spindle water outlet is out of registry with said second housing water outlet, to allow water flow through said first spindle water outlet and said first housing water outlet and, as said spindle continues to rotate, said second spindle water outlet comes into registry with said second housing water outlet while said first spindle water outlet is out of registry with said first housing water outlet, to allow water flow through said second spindle water outlet and said second housing water outlet, said first and second housing water outlets being in fluid flow communication, alternately, with said water heads.

14. A method of massaging the limbs of a patient with pulsating jets of water comprising the steps of:
surrounding and enclosing the limb to be massaged with a waterproof, flexible sleeve;
positioning at least two water heads peripherally spaced apart about said sleeve, each head having at least one opening facing said sleeve;
directing pulsating jets of water against the sleeve from said openings to massage peripherally spaced portions of the limb within said sleeve while, at the same time, moving said water heads longitudinally, back and forth, along said sleeve to massage longitudinally spaced portions of the limb within said sleeve.

15. A method, as claimed in claim 14, wherein said at least two hollow water heads comprise a continuous hollow water head surrounding said sleeve within said chamber, said head having peripherally spaced apart openings facing said sleeve.

16. A method, as claimed in claim 14, wherein said at least two hollow water heads comprise at least two continuous hollow water heads longitudinally spaced apart along said sleeve, each of said hollow water heads surrounding said sleeve within said chamber and having peripherally spaced apart openings facing said sleeve.

17. A method, as claimed in claim 16, wherein said continuous hollow water heads comprise ring tori and wherein each said ring torus of adjacent ring tori has a first set of one or more openings positioned diametrically opposed to a second set of one or more openings and the diameters connecting the first and second sets of openings in each ring torus form an angle with each other.

18. A method, as claimed in claim 17, wherein said angle is about 90°.
